(19) United States
(12) Patent Application Publication
(10) Pub. No.: US 2024/0051869 A1
(43) Pub. Date: Feb. 15, 2024

(54) PRODUCTION METHOD OF READY INJECTION MATERIAL INCLUDING NANO HYDRAULIC LIME

(71) Applicant: YILDIZ TEKNIK UNIVERSITESI, Istanbul (TR)

(72) Inventors: Nabi YUZER, Istanbul (TR); Afife Binnaz HAZAR, Istanbul (TR); Mehmet Fevzi UGURYOL, Istanbul (TR); Didem OKTAY, Istanbul (TR); Mehmet Bugra GUNER, Istanbul (TR)

(73) Assignee: YILDIZ TEKNIK UNIVERSITESI, Istanbul (TR)

(21) Appl. No.: 18/039,981

(22) PCT Filed: Oct. 18, 2021
(86) PCT No.: PCT/TR2021/051056

§ 371 Date: Jun. 2, 2023

(30) Foreign Application Priority Data
Dec. 10, 2020 (TR) 2020/20183

(51) Int. Cl. C04B 7/34; C04B 7/43; C04B 7/52; C04B 103/30

(52) U.S. Cl. CPC C04B 7/34; C04B 7/434; C04B 7/52; C04B 2103/34

(57) ABSTRACT

Clean version of the Abstract A production method of ready injection material aims at developing natural hydraulic lime at nano-size by using a single raw material. The production method includes: selecting marl, comprising at least 70% CaCO₃, as the raw material, grinding the marl to have particle size lower than 400 lam, calcining the marl at a temperature between 1000-1200° C., re-grinding the marl after the calcination process, reducing a d₉₀ particle size of calcined marl to between 200-700 nm after the grinding process, applying a dry mixing process to the material having a reduced particle size, adding water to the material after dry mixing and applying mechanical mixing process during duration between 3-6 minutes at a revolution between 800-1000 rpm, adding super-fluidizing chemical additive to the obtained material, and mixing the material for duration between 3-6 minutes by using ultrasonic homogenizer and mechanic mixing.

### CROSS REFERENCE TO THE RELATED APPLICATIONS

This application is the national phase entry of International Application No. PCT/TR2021/051056, filed on Oct. 18, 2021, which is based upon and claims priority to Turkish Patent Application No. 2020/20183, filed on Dec. 10, 2020, the entire contents of which are incorporated herein by reference.

### TECHNICAL FIELD

The present invention relates to production method of ready injection material including nano hydraulic lime which provides better injectability when compared with conventional natural hydraulic lime.

### BACKGROUND

Injection method (grouting) is one of the frequent methods used in restoration of historical structures. While injection application is being realized, the injection material to be used must be compliant to the unique material which exists in the historical structure and must be able to penetrate into the crack where repair shall be made. In order to increase injection performance of injection materials, the particle sizes of the materials which exist in the composition thereof must be taken into account. By means of injection materials produced by using nano-sized lime, much thinner cracks can be easily repaired. By means of the present art, it is difficult to provide penetration, volume fixedness and resistance values needed for reinforcing the historical structures.

By means of the present invention, it is aimed to produce lime which is suitable for injection and which is more resistant. In the known state of the art, there are separate studies related to nano-sized lime production and natural hydraulic lime production. In the subject matter invention, by using a single raw material, natural hydraulic lime can be developed in nano size.

The structural and characteristic properties and all advantages of the present invention will be understood in a more clear manner by means of the below mentioned detailed description, and therefore, evaluation shall be made by taking into consideration this detailed description.

### SUMMARY

In this detailed description, the subject matter production method of ready injection material including nano hydraulic lime is explained with references to examples without forming any restrictive effect only in order to make the subject more understandable.

By means of the subject matter method, nano-sized hydraulic lime production is realized. As a result of this method, lime is formed which is suitable for injection and which is resistant. Particularly the usage of a single material as raw material is one of the most important steps of the method.

The present invention relates to the production method of ready injection material including nano hydraulic lime, said production method is characterized by comprising the steps of:
a. Selecting marl (clayed limestone), comprising at least 70% CaCO₃, as the raw material,
b. Grinding marl (clayed limestone), selected as the raw material, so as to have particle size lower than 400 μm,
c. Calcining marl (clayed limestone), which is the raw material, at temperature between 1000-1200° C.,
d. Re-grinding marl (clayed limestone), which is the raw material, after the calcination process,
e. Reducing d₉₀ particle size of calcined marl to between 200-700 nm after the grinding process,
f. Applying dry mixing process to the material which has a reduced particle size,
g. Adding water to the material after dry mixing and applying mechanical mixing process during duration between 3-6 minutes at a revolution between 800-1000 rpm,
h. Adding super-fluidizing chemical additive to the obtained material,
i. Mixing the material for duration between 3-6 minutes by using ultrasonic homogenizer and mechanic mixing.

In step a), said marl (clayed limestone), which comprises at least 70% CaCO₃, also comprises SiO₂, Al₂O₃, Fe₂O₃ and MgO compounds.

In step b), whole product is grinded so as to have particle size lower than 400 μm.

In step e), d₉₀ particle size of the calcined marl is preferably between 440-550 nm.

In step e), d₉₀ particle size of the calcined marl is preferably 486 nm.

In step g), the water/dry powder proportion is between 1.6-1.9 by weight. In this step, the added water provides fluidity, volume fixedness and penetration characteristics to the material.

In step h), the super-fluidizer chemical additive added to the material is selected from a group formed by naphthalene or poly-carboxylate-based super-fluidizers.

### DETAILED DESCRIPTION OF THE EMBODIMENTS

The most important element of the subject matter production method of ready injection material comprising nano hydraulic lime is the raw material selection. The material, used in grinding process which is one of the steps of the method, is brought to nano size. Another important step is calcination. Calcination is the main process of lime production. The raw material, brought to the desired size, is calcined at suitable temperature by means of known methods and natural hydraulic lime production is realized.

In the step of preparation of the injection material which is one of the most important steps of said method, the limit conditions for fluidity, volume fixedness and penetration characteristics, which must be fulfilled by the injection materials, are provided by means of the selected water amount, chemical additive proportion and the applied mixing procedure.

The subject matter production method of ready injection material including nano hydraulic lime has been developed for eliminating the disadvantages formed by the present art.

From another perspective, the present invention relates to ready injection material including nano hydraulic lime obtained by means of the subject matter production method.

The ready injection materials produced by means of the subject matter method differentiate from the materials obtained by means of known methods since the subject matter ready injection materials have higher hydraulic effects and thus they have higher resistance.

Accordingly, another element of the present invention is ready injection material including nano hydraulic lime, wherein said ready injection material is obtained by means of the method comprising the steps of:
a. Selecting marl (clayed limestone), comprising at least 70% CaCO₃, as the raw material,
b. Grinding marl (clayed limestone), selected as the raw material, so as to have particle size lower than 400 μm,
c. Calcining marl (clayed limestone), which is the raw material, at temperature between 1000-1200° C.,
d. Re-grinding marl (clayed limestone), which is the raw material, after the calcination process,
e. Reducing d₉₀ particle size of calcined marl to between 200-700 nm after the grinding process,
f. Applying dry mixing process to the material which has a reduced particle size,
g. Adding water to the material after dry mixing and applying mechanical mixing process during duration between 3-6 minutes at a revolution between 800-1000 rpm,
h. Adding super-fluidizing chemical additive to the obtained material,
i. Mixing the material for duration between 3-6 minutes by using ultrasonic homogenizer and mechanic mixing.

It is apparent that a person skilled in the art can provide the novelty, provided in the present invention, by using similar methods and/or can apply this method also to other fields with similar purposes used in the related art. Thus, it is also apparent that such methods lack the criterion of novelty and particularly the criterion of surpassing the known state of the art.

Now, the present invention will be described with the below mentioned examples without realizing any limitation related to the scope.

### EXAMPLES

### Example 1: Sieve Analysis Results for the Calcined Marl after the Grinding Process

Sieve analysis test has been made to the marl which has been calcined in accordance with the present invention. The analysis results are given in Table 1.

TABLE 1
Sieve analysis results for the calcined
marl after the grinding process

| Sieve analysis test | Grinded sample |
|---|---|
| Average particle size | 416 nm |
| −204 nm | 0.82% |
| −243 nm | 5.88% |
| −289 nm | 19.15% |
| −344 nm | 40.8% |
| −409 nm | 67.55% |
| −486 nm | 90.42% |
| −578 nm | 99.04% |
| −687 nm | 100.00% |

The above mentioned table comprises the sieve analysis test results related to the subject matter product. The grinded sample is passed through sieves with different size range and the percent of the passing material is calculated.

As also seen in the table, the particle size of the calcined marl shows a distribution between 200 nm and 700 nm after the grinding process.

As mentioned in the table, only 0.82% of the material has passed through the sieve which has a gap of 204 nm.

When the sieve gap is 687 nm, all of the material has passed through the sieve. Approximately 90% of the grinded calcined marl has passed through the sieve which has a size of 486 nm.

### Example 2: Determination of the Flow Characteristics of the Ready Injection Material Comprising Nano Hydraulic Lime

The experiments made and the obtained results are given in Table 2.

TABLE 2
Flow characteristics of the subject matter nano lime material

| Experiments | | | Limits | Result |
|---|---|---|---|---|
| Starter Funnel | t₀, | seconds | <45 seconds | 20 |
| Flow Cone | t₀, | seconds | <25 seconds | 8 |
| Sweating (24^{th} hour) | B, % | | <%5 | 4.5 |
| Sand Column | T₃₆, | seconds | <50 seconds | 6 |

| | | |
|---|---|---|
| 20 ml material | Applicable | Not have been |
| collection, seconds | (EN 1771) | collected |

1. Starter Funnel: It is used in viscosity measurement of fluid materials, by means of measuring the flow duration. The duration of passage of the fluid material through the funnel is calculated. The subject matter product has passed through the funnel within 20 seconds. Thus, the limit which is under 45 seconds described in the standards has been provided.
2. Flow Cone: It is used for measuring flow viscosities of liquid materials like mud and mortar. The subject matter product has discharged from the cone within 8 seconds. Thus, the limit which is under 25 seconds described in the standards has been provided.
3. Sweating: Observation is made at 24th hour at the application point of the material in sweating test. The water, which exists in the mixture of said material, is separated from the material at 24th hour, and it forms the sweating event at the application region. This separation must be under 5% in accordance with the standards. In the subject matter product, the sweating proportion has been observed as 4.5%.
4. Sand Column: It is used in measuring the penetration of the injection materials into the cracks. The material is passed through a column where sand and pebbles which have different particle sizes exist. During this passage, it is expected that the material is not collected at any location of the columns and the material has specific passage duration. This passage duration and collection amount has been defined as lower than 50 seconds and 20 ml as standard. The subject matter product has passage duration of 6 seconds and no collection has been observed. Thus, it is seen that the subject matter product can penetrate even into the thinnest cracks.

When the result of the made tests is examined, it is seen that the obtained product is below the lower limits mentioned in the standards and that a material is obtained which shows superior performance in sand column test and which has high penetration in a compliant manner to the aim of the present invention.

What is claimed is:

1. A production method of ready injection material comprising nano hydraulic lime, comprising:
step a): selecting marl (clayed limestone), comprising at least 70% CaCO₃, as a raw material,
step b): grinding the marl (clayed limestone), to have particle size lower than 400 μm,
step c): calcining the marl (clayed limestone) at a temperature between 1000° C. and 1200° C.,
step d): re-grinding the marl (clayed limestone) after a calcination process,
step e): reducing a d₉₀ particle size of calcined marl to be between 200 nm and 700 nm after a grinding process,
step f): applying a dry mixing process to a material having a reduced particle size,
step g): adding water to the material after the dry mixing process and applying a mechanical mixing process during duration between 3 minutes and 6 minutes at a revolution between 800 rpm and 1000 rpm,
step h): adding super-fluidizing chemical additive to the obtained material, and
step i): mixing the material for duration between 3 minutes and 6 minutes by using ultrasonic homogenizer and mechanic mixing.

2. The production method according to claim 1, wherein in step a), the marl (clayed limestone) comprises at least 70% CaCO₃, SiO₂, Al₂O₃, Fe₂O₃ and MgO compounds.

3. The production method according to claim 1, wherein in step e), the d₉₀ particle size is between 440 nm and 550 nm.

4. The production method according to claim 1, wherein in step e), the d₉₀ particle size is 486 nm.

5. The production method according to claim 1, wherein in step g), a water/dry powder proportion is between 1.6 and 1.9 by weight.

6. The production method according to claim 1, wherein in step h), the super-fluidizing chemical additive added to the material is selected from a group formed by naphthalene or poly-carboxylate-based super-fluidizers.

7. The production method according to claim 2, wherein in step e), the d₉₀ particle size is between 440 nm and 550 nm.

8. The production method according to claim 2, wherein in step e), the d₉₀ particle size is 486 nm.

9. The production method according to claim 3, wherein in step e), the d₉₀ particle size is 486 nm.

10. The production method according to claim 2, wherein in step g), a water/dry powder proportion is between 1.6 and 1.9 by weight.

11. The production method according to claim 3, wherein in step g), a water/dry powder proportion is between 1.6 and 1.9 by weight.

12. The production method according to claim 4, wherein in step g), a water/dry powder proportion is between 1.6 and 1.9 by weight.

13. The production method according to claim 2, wherein in step h), the super-fluidizing chemical additive added to the material is selected from a group formed by naphthalene or poly-carboxylate-based super-fluidizers.

14. The production method according to claim 3, wherein in step h), the super-fluidizing chemical additive added to the material is selected from a group formed by naphthalene or poly-carboxylate-based super-fluidizers.

15. The production method according to claim 4, wherein in step h), the super-fluidizing chemical additive added to the material is selected from a group formed by naphthalene or poly-carboxylate-based super-fluidizers.

16. The production method according to claim 5, wherein in step h), the super-fluidizing chemical additive added to the material is selected from a group formed by naphthalene or poly-carboxylate-based super-fluidizers.
